(19) United States
(12) Patent Application Publication
(10) Pub. No.: US 2025/0388726 A1
(43) Pub. Date: Dec. 25, 2025

(54) PROCESS FOR THE PRODUCTION OF POLYARYLENE(ETHER)SULFONES WITH IMPROVED PERFORMANCE

(71) Applicant: BASF SE, Ludwigshafen am Rhein (DE)

(72) Inventors: Martin WEBER, Ludwigshafen am Rhein (DE); Christian MALETZKO, Altrip (DE); Christoph SIGWART, Ludwigshafen am Rhein (DE); Bernd TROTTE, Schriesheim (DE); Bastiaan Bram Pieter STAAL, Ludwigshafen am Rhein (DE); Joachim STRAUCH, Ludwigshafen am Rhein (DE)

(21) Appl. No.: 18/880,599

(22) PCT Filed: Jun. 26, 2023
(86) PCT No.: PCT/EP2023/067324

§ 371 Date: Jan. 2, 2025

(30) Foreign Application Priority Data
Jul. 6, 2022 (EP) 22183251.2

(51) Int. Cl. C08G 75/23; C08J 5/22

(52) U.S. Cl. CPC C08G 75/23; C08J 5/2256; C08J 2381/06

(57) ABSTRACT

This invention relates to a process for the production of polyarylene(ether)sulfones having high molecular weight and excellent purity as well as low content of undesired volatiles and a reduced content of cyclic oligomers, the polyarylene(ether)sulfones resulting from the inventive process, as well as parts made from the inventive polyarylene(ether)sulfones such as membranes.

This invention relates to a process for the production of polyarylene(ether)sulfones having high molecular weight and excellent purity as well as low content of undesired volatiles and a reduced content of cyclic oligomers, the polyarylene(ether)sulfones resulting from the inventive process, as well as parts made from the inventive polyarylene(ether)sulfones such as membranes.

Polyarylene(ether)sulfones belong to the group of high performance polymers and offer excellent heat resistance, good mechanical properties and high flame retardancy (E. M. Koch, H.-M. Walter, Kunststoffe 80 (1990) 1146; E. Döring, Kunststoffe 80, (1990) 1149, N. Inchaurondo-Nehm, Kunststoffe 98, (2008) 190).

The production of polyarylene(ether)sulfones can be done by either using the so-called “hydroxide-method”, wherein a phenolate is formed by the reaction of the dihydroxy monomer component and a hydroxide. Another method is the so-called “carbonate route”, wherein the monomers are dissolved in a solvent and then potassium carbonate is added. General information with respect to both synthetic methods can be found in the literature (e.g. R. N. Johnson et. al., J. Polym. Sci. A-1 5 (1967) 2375, J. E. McGrath et. al., Polymer 25 (1984) 1827).

Processes for preparing polyarylene(ether)sulfones based on aromatic bishalogen compounds and aromatic bisphenols or their salts in the presence of at least one alkalimetal carbonate or alkalimetal hydrocarbonate, ammonium carbonate or ammonium hydrocarbonate in an aprotic solvent are well known (see, for example U.S. Pat. No. 4,870,153, EP 113 112, EP-A 297 363 and EP-A 135 130, WO2019/002226, WO2013/020871 and WO2014/177638). Therein, particularly appropriate monomers, catalysts and solvents, appropriate ratios of the components, reaction conditions, like temperature, pressure, mixing conditions and work-up conditions, can be found.

As known from the literature (see for example Savariar et. al., Desalination 144 (2002) 15-20), polyarylene(ether)sulfones contain significant amounts of unwanted cyclic oligomers. Out of those, particularly the cyclic dimers tend to crystallize from solution, which causes problems during the processing of polyarylene(ether)sulfone solutions for example in membrane production processes. Since most micro- and ultrafiltration membranes are prepared by phase inversion processes from solution, products with reduced content of cyclic oligomers such as cyclic dimers are needed. There is need for an improved process resulting in products with low cyclic dimer content without the need to remove the cyclic dimer in a subsequent purification step. As known from the literature, products with cyclic dimer content of about 1.2 wt. % are available on the market. However, especially for the production of membranes, the lower the content of any cyclic oligomers and dimers the better. In particular, a process that results in high molecular weight polymers and, at the same time, in levels of cyclic dimer below 1.2 wt % is highly desirable. Furthermore, a common problem of commercially available polyarylene(ether)sulfones is that the amounts of unwanted aromatic volatiles such as toluene and/or chlorobenzene are too high. Volatiles can migrate from membranes made from material containing aromatic volatiles which is unwanted and perturbing for most membrane applications.

An object of the present invention was to provide a process for the production of high molecular weight polyarylene(ether)sulfones containing a very low content of cyclic oligomers, in particular cyclic dimers. Also, an object was to provide polyarylene(ether)sulfones containing low amounts of aromatic volatiles like toluene and/or chlorobenzene and showing high purity. In particular, the polyarylene(ether)sulfone polymers shall be suitable for use in membranes.

The problem was solved by the process for the preparation of a polyarylene(ether)sulfone (P), comprising the following steps
I) providing a reaction mixture R^{M} at a start temperature T¹, the reaction mixture comprising
   A) at least one aromatic dihalogen sulfone;
   B) at least one dihydroxy component;
   C) at least one carbonate component in an excess amount of at least 3 mol % in relation to the dihydroxy component B); and
   D) at least one aprotic solvent;
   wherein the initial concentration of each of the monomers A) and B) in the reaction mixture R^{M} is 2.2 to 2.7 mol per one liter of the at least one aprotic solvent D); and
II) heating the reaction mixture R^{M} from the start temperature T¹ to the final reaction temperature T^{F} with a rate of at least 0.4 K/min, wherein a product mixture (P^{M}) is obtained.

It has surprisingly been found that the inventive process results in high molecular weight poly-arylene(ether)sulfone polymers having a particularly low content of cyclic dimers and high purity, in particular with low turbidity and showing desirably low contents of aromatic volatiles such as chlorobenzene. The inventive process results in low contents of cyclic oligomers, low contents of undesired particles causing turbidity and volatiles without the necessity of performing a separate purification step to remove such substances from the polymer product. Furthermore, it has been found that the polymers obtained by this inventive process are highly suitable for the production of membranes, particularly in solution processes because no clogging of filters occurs during processing of polymer solutions prepared by using these polymers.

According to the inventive process, in step I), a reaction mixture R^{M} is provided comprising components A), B), C and D). Herein, each of the components A) and B) may also be called “monomer” or together they may also be called the “monomers”. Component C) acts as a base to deprotonate component B) and component D) acts as a solvent during the polycondensation reaction. The reaction mixture R^{M} is provided at start temperature T¹.

The reaction mixture R^{M} is the mixture provided at the beginning of the reaction, i.e. before the actual process takes place, namely the polycondensation between the monomers A) and B). During the process of the present invention, the reaction mixture R^{M} undergoes conversion into the product mixture P^{M} under the inventive reaction conditions, wherein the reaction mixture R^{M} is heated to a certain final reaction temperature T^{F}, where the polycondensation reaction pre-dominantly takes place. The polycondensation reaction results in the desired poly-arylene(ether)sulfone polymer (P) product. The mixture obtained after polycondensation has taken place is also referred to as product mixture P^{M}. The product mixture contains the desired polyarylene(ether)sulfone polymer (P), but usually also component D) and a halide compound that is formed during the conversion of the reaction mixture R^{M}. In the conversion of the reaction mixture, the component C) deprotonates component B), and deprotonated component B) reacts with component A), wherein a halide is formed.

The process of the invention is carried out according to the so called “carbonate method”, it is not carried out according to the so called “hydroxide method” with isolation of phenolate anions. In one embodiment, the reaction mixture (R^{M}) is essentially free from sodium hydroxide and potassium hydroxide. More preferably, according to this embodiment, the reaction mixture (R^{M}) is essentially free from alkali metal hydroxides and alkali earth metal hydroxides. The term “essentially free” in the present case is understood to mean that the reaction mixture (R^{M}) comprises less than 100 ppm, preferably less than 50 ppm of sodium hydroxide and potassium hydroxide, preferably of alkali metal hydroxides and alkali earth metal hydroxides, based on the total weight of the reaction mixture (R^{M}). It is furthermore preferred that the reaction mixture (R^{M}) does not comprise toluene. It is particularly preferred that the reaction mixture (R^{M}) does not comprise any substance which forms an azeotrope with water.

Herein, “at least one” may in general mean one or two or more, such as three or four or five or more, wherein more may mean a plurality or an uncountable. For instance, it may mean one or a mixture of two or more. If used in connection with chemical compounds “at least one” is meant in the sense that one or two or more chemical compounds differing in their chemical constitution, that is chemical nature, are described.

According to step I) of the inventive process, the reaction mixture R^{M} comprises at least one aromatic dihalogen sulfone as component A).

The at least one aromatic dihalogen sulfone A) is preferably at least one dihalodiphenyl sulfone. The present invention therefore also relates to a method in which the reaction mixture (R^{M}) comprises at least one dihalodiphenyl sulfone as component A). The reaction mixture R^{M} comprises preferably at least 50% by weight of a dihalodiphenyl sulfone as component A), based on the total weight of component A) in the reaction mixture R^{M}. Preferred dihalodiphenyl sulfones are selected from 4,4′-dihalodiphenyl sulfones. Particularly preferred, the at least one component A) is selected from 4,4′-dichlorodiphenyl sulfone, 4,4′-difluorodiphenyl sulfone and 4,4′-dibromodi-phenyl sulfone.

According to one embodiment, the at least one aromatic dihalogen sulfone of component A) is 4,4′-dichlorodiphenyl sulfone.

According to a further embodiment, the at least one aromatic dihalogen sulfone of component A) is 4,4′-difluorodiphenyl sulfone.

The present invention therefore also relates to a method wherein component A) comprises at least 50% by weight of at least one aromatic dihalogen sulfone selected from the group consisting of 4,4′-dichlorodiphenyl sulfone and 4,4′-difluorodiphenyl sulfone, based on the total weight of component A) in the reaction mixture (R^{M}).

In a particularly preferred embodiment, component A) comprises at least 80% by weight, preferably at least 90% by weight, more preferably at least 98% by weight, of an aromatic dihalogen sulfone selected from the group consisting of 4,4′-dichlorodiphenyl sulfone and 4,4′-difluorodiphenyl sulfone, based on the total weight of component A) in the reaction mixture (R^{M}). In a further particularly preferred embodiment, component A) consists essentially of at least one aromatic dihalogen sulfone selected from the group consisting of 4,4′-dichlorodiphenyl sulfone and 4,4′-difluorodiphenyl sulfone. “Consisting essentially of”, in the present case, is understood to mean that component A) comprises more than 99% by weight, preferably more than 99.5% by weight, particularly preferably more than 99.9% by weight, of at least one aromatic dihalogen sulfone compound selected from the group consisting of 4,4′-dichlorodiphenyl sulfone and 4,4′-difluorodiphenyl sulfone, based in each case on the total weight of component A) in the reaction mixture R^{M}. In the above embodiments, 4,4′-dichlorodiphenyl sulfone is particularly preferred as component A).

In a further particularly preferred embodiment, component A) consists of 4,4′-dichlorodiphenyl sulfone.

The reaction mixture R^{M} comprises at least one dihydroxy component B). The dihydroxy components used are typically components having two phenolic hydroxyl groups. Since the reaction mixture R^{M} comprises at least one carbonate component, the hydroxyl groups of component B) in the reaction mixture R^{M} may be present partially in deprotonated form.

Component B) may be selected from the following compounds:
dihydroxybenzenes, especially hydroquinone and resorcinol;
dihydroxynaphthalenes, especially 1,5-dihydroxynaphthalene, 1,6-dihydroxynaphthalene, 1,7-dihydroxynaphthalene, and 2,7-dihydroxynaphthalene;
dihydroxybiphenyls, especially 4,4′-biphenol and 2,2′-biphenol;
bisphenyl ethers, especially bis(4-hydroxyphenyl) ether and bis(2-hydroxyphenyl) ether;
bisphenylpropanes, especially 2,2-bis(4-hydroxyphenyl) propane, 2,2-bis(3-methyl-4-hydroxyphenyl) propane and 2,2-bis(3,5-dimethyl-4-hydroxyphenyl) propane;
bisphenylmethanes, especially bis(4-hydroxyphenyl)methane;
bisphenyl sulfones, especially bis(4-hydroxyphenyl) sulfone;
bisphenyl sulfides, especially bis(4-hydroxyphenyl) sulfide;
bisphenyl ketones, especially bis(4-hydroxyphenyl) ketone;
bisphenylhexafluoropropanes, especially 2,2-bis(3,5-dimethyl-4-hydroxyphenyl)hexafluoropropane; and
bisphenylfluorenes, especially 9,9-bis(4-hydroxyphenyl)fluorene.

Particularly preferred, monomer component B) is selected from dihydroxybiphenyls, such as 4,4′-biphenol, bisphenylpropanes, such as 2,2-bis(4-hydroxyphenyl)propane (Bisphenol A) and bisphenyl sulfones, such as bis(4-hydroxyphenyl) sulfone.

The monomer component B) may, according to a further preferred embodiment, also be selected from the group of hydroquinone, resorcinol, dihydroxynaphthalene, especially 2,7-dihydroxynaphthalene, bisphenol A, dihydroxydiphenyl sulfone and 4,4′-biphenol.

According to a further embodiment, it is possible to use trifunctional compounds as component B). In this case, branched structures are the result. If a trifunctional component B) is used, preference is given to 1,1,1-tris(4-hydroxyphenyl)ethane.

The ratio of component A) and component B) derives in principle from the stoichiometry of the polycondensation reaction which proceeds with theoretical elimination of hydrogen chloride, and it is established by the person skilled in the art in a known manner. To control the end groups in the resulting end product, the ratio of component B) to component A) can be adjusted accordingly. More particularly, the molar ratio of component B) to component A) is from 0.98 to 1.08, especially from 0.99 to 1.06, most preferably from 1.000 to 1.05. The molar ratio of B) to A) may also be 1 to 1.

According to the present invention, is has been found that the initial concentration of each monomer A) and B) in the reaction mixture R^{M} is critical and that it has to be 2.2 to 2.7 mol per liter of the at least one aprotic solvent component D), in particular 2.2 to 2.67, more specifically 2.2 to 2.65, even more specifically 2.2 to 2.6. According to a further embodiment, it may be preferred, if the monomer concentration in R^{M} is 2.2 to 2.55, more particularly 2.2 to 2.5 and even more specifically 2.2 to 2.45 mol per liter of the at least one aprotic solvent component D). The preferred ranges apply independently to each of the monomers A) and B).

According to the process of the invention, the reaction mixture R^{M} comprises at least one carbonate component in an excess amount of at least 3 mol % in relation to the dihydroxy-component B) as component C).

“At least one carbonate component” is understood to mean exactly one carbonate component and also mixtures of two or more carbonate components. The at least one carbonate component is preferably at least one metal carbonate. The metal carbonate is preferably anhydrous. Preference is given to alkali metal carbonates and/or alkaline earth metal carbonates as metal carbonates. At least one metal carbonate selected from the group consisting of sodium carbonate, potassium carbonate and calcium carbonate is particularly preferred as metal carbonate. Potassium carbonate is most preferred. For example, component C) comprises at least 50% by weight, more preferred at least 70% by weight and most preferred at least 90% by weight of potassium carbonate based on the total weight of the at least one carbonate component in the reaction mixture R^{M}. Therefore, a further embodiment of the present invention is a process wherein component C) comprises at least 50% by weight of potassium carbonate, based on the total weight of component C). In a preferred embodiment component C) consists essentially of potassium carbonate. “Consisting essentially of” is understood to mean that component C) comprises more than 99% by weight, preferably more than 99.5% by weight, particular preferably more than 99.9% by weight of potassium carbonate based in each case on the total weight of component C) in the reaction mixture R^{M}. In a particularly preferred embodiment component C) consists of potassium carbonate. Potassium carbonate having a volume weighted average particle size of less than 200 μm is particularly preferred as potassium carbonate. The volume weighted average particle size of the potassium carbonate is determined in a suspension of potassium carbonate in N-methylpyrrolidone using a particle size analyser. In a specific embodiment, the reaction mixture R^{M} is essentially free of alkali metal hydroxides or alkaline earth metal hydroxides as detailed above.

Component C) is present in an excess amount of at least 3 mol % in relation to the dihydroxy-component B), in particular the excess of component C) is at least 4 mol %, specifically 5 mol % or more. In specific embodiments, it may be preferred, if C) is used in an excess amount of at least 6 mol %, at least 7.5 mol %, at least 10 mol % or at least 12.5 mol %, respectively. According to one embodiment, the excess of component C) in relation to component B) is 3 mol % to 20 mol %, more specifically 4 to 20 mol %, even more specifically 5 to 20 mol %. According to a particular embodiment, the excess of component C) in relation to component B) is 3 mol % to 18 mol %, more specifically 3 to 15 mol %, even more specifically 3 to 13 mol %.

The reaction mixture R^{M} comprises at least one aprotic polar solvent as component D). “At least one aprotic polar solvent”, according to the invention, is understood to mean exactly one aprotic polar solvent and also mixtures of two or more aprotic polar solvents. Suitable aprotic polar solvents are, for example, selected from the group consisting of anisole, dimethylformamide, dimethylsulfoxide, sulfolane, N-methylpyrrolidone, N-ethylpyrrolidone and N-dimethylacetamide. Preferably, component D) is selected from the group consisting of N-methylpyrrolidone, N-dimethylacetamide, dimethylsulfoxide and dimethylformamide. N-methylpyrrolidone is particularly preferred as component D).

According to one embodiment of the present invention, the component D) used in the inventive process is selected from the group consisting of N-methylpyrrolidone, N-dimethylacetamide, dimethylsulfoxide and dimethylformamide.

In particular, it may be preferred that component D) comprises at least 50% by weight of at least one solvent selected from the group consisting of N-methylpyrrolidone, N-dimethylacetamide, dimethylsulfoxide and dimethylformamide based on the total weight of component D) in the reaction mixture R^{M}. N-methylpyrrolidone is particularly preferred as component D). In a further preferred embodiment, component D) consists essentially of N-methylpyrrolidone. “Consist essentially of” is understood to mean that component D) comprises more than 98% by weight, particularly preferably more than 99% by weight, more preferably more than 99.5% by weight, of at least one aprotic polar solvent selected from the group consisting of N-methylpyrrolidone, N-dimethylacetamide, dimethylsulfoxide and dimethylformamide with preference given to N-methylpyrrolidone. In specific embodiment of the invention, component D) consists of N-methylpyrrolidone. N-methylpyrrolidone is also referred to as NMP or N-methyl-2-pyrrolidone.

In step I) of the inventive process, the reaction mixture R^{M} is provided at start temperature T¹. T¹ can be for example ambient temperature, such as 20 to 27° C., in particular 20 to 25° C., such as 21° C., 22° C., 23° C. and 24° C. The process is not limited to this T¹, T¹ may also be 20 to 80° C. or T¹ can simply be the temperature that is naturally present in the environment where the reaction takes place. The more important feature of the inventive process is the rate of temperature change starting at T¹ to the final reaction temperature T^{F}.

According to step II) of the inventive process, the reaction mixture R^{M} is heated from the start temperature T¹ to the final reaction temperature T^{F} with a rate of at least 0.4 K/min.

Consequently, the heating rate characterizing the inventive process is at least 0.4 K/min. It may be preferred, if the rate is at least 0.45 K/min, more specifically at least 0.5 K/min. According to a further specific embodiment of the invention, the rate is at least 0.55 K/min, even more specifically the rate is at least 0.6 K/min. The limit of the rate is given by the capacity of the device where the reaction takes place, naturally depending on whether the reaction is carried out in laboratory scale or in semi-industrial or industrial scale. The final reaction temperature T^{F} depends on the exact reactants and solvent(s) used and the upper limit of the temperature is determined by the boiling point of the at least one aprotic solvent (component D)) at standard pressure (1013.25 mbar). T^{F} is usually in a range of 80 to 250° C., preferably 100 to 220° C. It may be preferred if T^{F} is in the range of 130° C. to 200° C., in particular 150° C. to 195° C. Temperatures T^{F} of 160° C. to 190° C., such as 180° C. to 190° C. can be preferred.

The process according to the invention is generally preferably carried out at standard pressure. When T^{F} is reached, the mixture is preferably held at this temperature for a time interval of 2 to 12 hours, particularly for a range of 3 to 10 hours, this time is called the “reaction time” herein.

As explained above and generally known to the skilled person, besides the desired polymer (P), the product mixture P^{M} also comprises a halide compound that is formed during the conversion of the reaction mixture R^{M}. Depending on the carbonate used as component C) and the aromatic dihalogen sulfone used as monomer B), for example potassium chloride may be formed during the reaction.

In one embodiment, the halide compound is separated off from the product mixture P^{M} after step II), wherein the separation of the halide compound can be carried out by any method known to the skilled person, for example via filtration or centrifugation. The present invention therefore also provides a process furthermore comprising step IIIa) filtration of the product mixture (P^{M}) obtained in step II).

In step IIIa), the halide compound is being removed, most preferably resulting in a halide compound-free product mixture (P^{M}). However, the P^{M} may still comprise traces of the halide compound. “Traces of the halide compound” in this context means less than 0.5% by weight, preferably less than 0.1% by weight and most preferably less than 0.01% by weight of the respective halide compound, based on the total weight of the product mixture P^{M}. After step IIIa), the product mixture (P^{M}) usually comprises at least 0.0001% by weight, such as at least 0.0005% by weight or at least 0.001% by weight of the halide compound, based on the total weight of the product mixture (P^{M}).

The isolation of the polyarylene(ether)sulfone polymer (P) obtained in the process according to the present invention and comprised in the product mixture (P^{M}) may be carried out for example by precipitation of the product mixture (P^{M}) in water or mixtures of water with other solvents. The precipitated polyarylene(ether)sulfone polymer (P) can subsequently be extracted with water and then be dried. In one embodiment of the invention, the precipitate can also be taken up in an acidic medium. Suitable acids are for example organic or inorganic acids for example carboxylic acid such as acetic acid, propionic acid, succinic acid or citric acid and mineral acids such as hydrochloric acid, sulfuric acid or phosphoric acid.

Consequently, in a further embodiment, the present invention therefore also provides a process comprising step IIIb) isolation of the polyarylene(ether)sulfone polymer (P) from the product mixture (P^{M}).

Step IIIb) is optional and may be carried out subsequently to step II) or step IIIa), if IIIa) filtration is part of the process.

Herein “polymer” may mean homopolymer or copolymer or a mixture thereof. The person skilled in the art appreciates that any polymer, may it be a homopolymer or a copolymer by nature typically is a mixture of polymeric individuals differing in their constitution such as chain length, degree of branching or nature of endgroups. Thus, in the following “at least one” as prefix to a polymer means that different types of polymers may be encompassed whereby each type may have the difference in constitution addressed above.

Polyarylene(ether)sulfones obtained by the inventive process are a class of polymers generally known to a person skilled in the art. It may be preferred that the polyarylene(ether)sulfone is composed of units of the general formula II

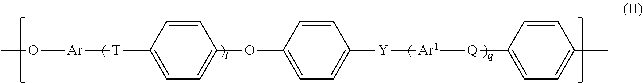

wherein the definitions of the symbols t, q, Q, T, Y, Ar and Ar¹ are as follows:
t, q independently of one another 0, 1, 2 or 3;
Q, T, Y independently of one another a chemical bond or a group selected from —O—, —S—, —SO₂—, S═O, C═O, —N═N— and —CR^{a}R^{b}—, wherein R^{a} and R^{b} independently of one another are a hydrogen atom, (C₁-C₁₂)alkyl, (C₁-C₁₂)alkoxy, (C₃-C₁₂)cycloalkyl or a (C₆-C₁₈)aryl group, and wherein at least one of Q, T, and Y is present and is —SO₂—; and
Ar and Ar¹ independently of one another (C₆-C₁₈)arylene.

If, within the abovementioned preconditions, Q, T or Y is a chemical bond, this means that the adjacent group on the left-hand side and the adjacent group on the right-hand side are present with direct linkage to one another via a chemical bond.

According to one preferred embodiment, t and q are independently 0 or 1.

According to one preferred embodiment, Q, T, and Y in formula II are independently selected from a chemical bond, —O—, —SO₂— and —CR^{a}R^{b}—, with the proviso that at least one of Q, T, and Y is present and is —SO₂—. Furthermore, it may be preferred, if R^{a} and R^{b} are, independently of one another, hydrogen or (C₁-C₄)alkyl.

In —CR^{a}R^{b}—, R^{a} and R^{b} are preferably independently selected from hydrogen, (C₁-C₁₂)alkyl, (C₁-C₁₂)alkoxy and (C₆-C₁₈)aryl.

(C₁-C₁₂)alkyl refers to linear or branched saturated hydrocarbon groups having from 1 to 12 carbon atoms. The following moieties are particularly encompassed: (C₁-C₆)alkyl, e.g. methyl, ethyl, n-propyl, isopropyl, n-butyl, sec-butyl, 2- or 3-methylpentyl, as well as (C₇-C₁₂)alkyl, e.g. unbranched heptyl, octyl, nonyl, decyl, undecyl, lauryl, and the singly branched or multi-branched analogs thereof.

The term “C₁-C₁₂-alkoxy” refers to a linear or branched alkyl group having 1 to 12 carbon atoms which is bonded via an oxygen, at any position in the alkyl group, e.g. methoxy, ethoxy, n-propoxy, 1-methylethoxy, butoxy, 1-methylpropoxy, 2-methylpropoxy or 1,1-dimethylethoxy.

(C₃-C₁₂)cycloalkyl refers to monocyclic saturated hydrocarbon radicals having 3 to 12 carbon ring members and particularly comprises (C₃-C₅)cycloalkyl, e.g. cyclopropyl, cyclobutyl, cyclo-pentyl, cyclohexyl, cycloheptyl, cyclooctyl, cyclopropylmethyl, cyclopropylethyl, cyclopropylpropyl, cyclobutylmethyl, cyclobutylethyl, cyclopentylethyl, -propyl, -butyl, -pentyl, -hexyl, cyclohex-ylmethyl, -dimethyl, and -trimethyl.

Ar and Ar¹ are independently of one another a (C₆-C₁₈)-arylene group. It may be preferred that, according to a specific embodiment, Ar¹ is an unsubstituted (C₆-C₁₂)arylene group.

It may be preferred that Ar and Ar¹ are independently selected from phenylene, bisphenylene and naphthylene groups, and from arylene groups that derive from anthracene, from phenanthrene, or from naphthacene. For examples, Ar and Ar¹ are independently selected from 1,2-phenylene, 1,3-phenylene, 1,4-phenylene, 1,6-naphthylene, 1,7-naphthylene, 2,6-naphthylene and 2,7-naphthylene, 2,7-dihydroxynaphthylene and 4,4′-bisphenylene. In particular, it may be preferred that Ar and Ar¹ are independently selected from phenylene and naphthylene groups, such as independently selected from 1,2-phenylene, 1,3-phenylene, 1,4-phenylene, 1,6-naphthylene, 1,7-naphthylene, 2,6-naphthylene and 2,7-naphthylene, more specifically independently selected from 1,4-phenylene, 1,3-phenylene and naphthylene. Furthermore, according to another embodiment of the present invention Ar and Ar¹ are independently selected from arylene groups that derive from anthracene, from phenanthrene, or from naphtha cene. According to still a further embodiment, Ar and Ar¹ are independently selected from 2,7-dihydroxynaphthylene and 4,4′-bisphenylene.

It may be preferred if the polyarylene(ether)sulfone comprises at least one of the following repeat units IIa to IIo:

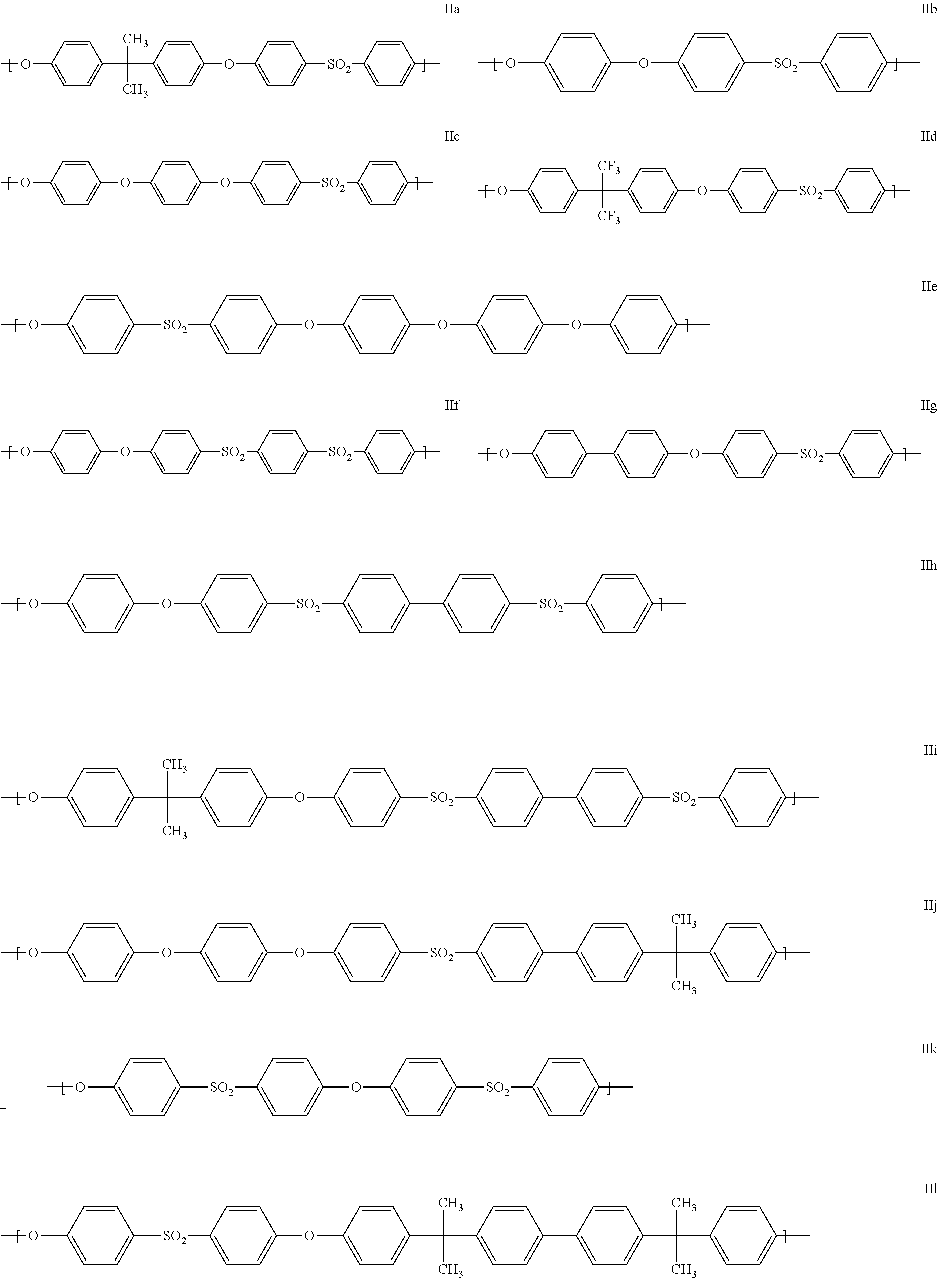

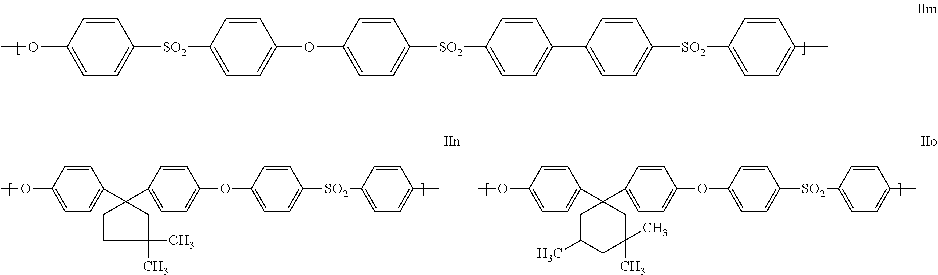

Other repeat units, in addition to the units IIa to IIo that may preferably be present, are those in which one or more 1,4-phenylene units deriving from hydroquinone have been replaced by 1,3-phenylene units deriving from resorcinol, or by naphthylene units deriving from dihydroxynaphthalene.

Units of the general formula II that are particularly preferred are the units IIa, IIg, and/or IIk. According to a specific embodiment, it is particularly preferred that the polyarylene(ether)sulfone is in essence composed of one type of unit of the general formula II, whereby said one type may particularly be selected from IIa, IIg, and IIk.

According to a preferred embodiment, the polyarylene(ether)sulfone is composed of repeat units where Ar is 1,4-phenylene, t is 1, q is 0, T is a chemical bond, and Y is SO₂. This poly-arylene(ether)sulfone is also termed polyphenylene sulfone (PPSU) (formula IIg).

According to a further preferred embodiment, the polyarylene(ether)sulfone is composed of repeat units where Ar is 1,4-phenylene, t is 1, q is 0, T is C(CH₃)₂, and Y is SO₂. This poly-arylene(ether)sulfone is also termed polysulfone (PSU) (formula IIa).

According to still a further preferred embodiment, the polyarylene(ether)sulfone is composed of repeat units where Ar is 1,4-phenylene, t is 1, q is 0, T and Y are SO₂. This poly-arylene(ether)sulfone is also termed polyether sulfone (PESU) (formula IIk).

For the purposes of the present disclosure, abbreviations such as PPSU, PESU, and PSU are in accordance with DIN EN ISO 1043-1:2001.

The polyarylene(ether)sulfones usually have halogen end groups, in particular —F or —Cl, or phenolic OH end groups or phenolate end groups, where the latter can be present as such or in reacted form, in particular in the form of —OCH₃ end groups. The amount of phenolic end groups can be determined by potentiometric titration.

For the purposes of the present invention, the expression “phenolic end group” means a hydroxy group bonded to an aromatic ring and optionally also present in deprotonated form. The person skilled in the art is aware that a phenolic end group can also take the form of what is known as a phenolate end group by virtue of cleavage of a proton as a consequence of expo-sure to a base. The expression “phenolic end groups” therefore expressly comprises not only aromatic OH groups but also phenolate groups.

The proportion of phenolic end groups is preferably determined via potentiometric titration. For this, the polymer is dissolved in dimethylformamide and is titrated with a solution of tetrabutylammonium hydroxide in toluene/methanol. The end point is recorded potentiometrically. The proportion of halogen end groups is preferably determined by means of elemental analysis. The amount of methoxy groups can be determined via ¹H-NMR. These techniques are well known to the skilled person.

The polyarylene(ether)sulfone polymer (P) obtainable by the inventive process preferably has a weight average molecular weight (Mw) in the range from 15 000 to 180 000 g/mol, more preferably in the range from 20 000 to 150 000 g/mol and particularly preferably in the range from 25 000 to 125 000 g/mol, determined by GPC (Gel Permeation Chromatography). GPC-Analysis is done using dimethylacetamide with 0.5 wt. % LiBr as solvent, the polymer concentration is 4 mg/mL. The system was calibrated with PMMA-standards. As columns three different Polyester-copolymer based units were used. After dissolving the material, the obtained solution was filtered using a filter with 0.2 μm pore size, then 100 μL solution were injected into the system, the elution rate was set at 1 mL/min. The polyarylene(ether)sulfone polymer (P) obtainable by the inventive process, furthermore, has preferably a number average molecular weight (Mn) in the range from 5 000 to 75 000 g/mol, more preferably in the range from 6 000 to 60 000 g/mol and particularly preferably in the range from 7 500 to 50 000 g/mol, determined by GPC (Gel Permeation Chromatography). GPC-analysis is performed as described above. The glass transition temperature (TG) of the polyarylene(ether)sulfone polymer (P) is typically in the range from 180 to 260° C., preferably in the range from 180 to 255° C. and particularly preferably in the range from 180 to 250° C. determined via differential scanning calorimetry (DSC) with a heating rate of 10 K/min in the second heating cycle. The viscosity number (V.N.) of the polyarylene (ether)sulfone polymer (P) is determined as a 1% solution in N-methylpyrrolidone at 25° C. The viscosity number (V.N.) is in particular in the range from 65 to 120 ml/g, typically >65 ml/g, preferably in the range from 66 to 100 ml/g, and most preferably in the range from 70 to 90 ml/g.

Surprisingly, by following the inventive process parameters as described herein in detail, the inventive process leads to very low amounts of cyclic dimer without a subsequent purification step. The “cyclic dimer” is an unwanted side product that can be formed during polycondensation, wherein the linear condensation product from two monomers A) and two monomers B) react under ring closure.

In particular, said composition comprises cyclic dimer in an amount of 1.1 wt % or less (0 to 1.1 wt %), in particular 1.0 wt % or less (0 to 1.0 wt %), more specifically 0.9 wt % or less (0 to 0.9 wt %).

According to one embodiment, the cyclic dimer content is from 0.1 to 1.1 wt %, in particular from 0.2 to 1.1 wt %, more specifically from 0.3 to 1.1 wt %, even more specifically 0.4 to 1.1 wt %. It may also be preferred if the cyclic dimer content is from 0.5 to 1.1 wt %, in particular from 0.6 to 1.1 wt %, more specifically from 0.7 to 1.1 wt %, even more specifically 0.8 to 1.1 wt %. Still a further embodiment relates to the polyarylene(ether)sulfone composition obtainable by the inventive process wherein the cyclic dimer content is from 0.9 to 1.1 wt %, in particular from 1.0 to 1.1 wt %.

According to still a further embodiment, the cyclic dimer content in the polyarylene(ether)sulfone composition obtainable by the inventive process is from 0.1 to 1.0 wt %, in particular from 0.2 to 1.0 wt %, more specifically from 0.3 to 1.0 wt %, even more specifically 0.4 to 1.0 wt %. It may also be preferred if the cyclic dimer content is from 0.5 to 1.0 wt %, in particular from 0.6 to 1.0 wt %, more specifically from 0.7 to 1.0 wt %, even more specifically 0.8 to 1.0 wt %. Still a further embodiment relates to the polyarylene(ether)sulfone composition obtainable by the inventive process wherein the cyclic dimer content is from 0.9 to 1.0 wt %.

Still a further embodiment relates to the polyarylene(ether)sulfone composition obtainable by the inventive process, wherein the cyclic dimer content in is from 0.1 to 0.9 wt %, in particular from 0.2 to 0.9 wt %, more specifically from 0.3 to 0.9 wt %, even more specifically 0.4 to 0.9 wt %. It may also be preferred if the cyclic dimer content is from 0.5 to 0.9 wt %, in particular from 0.6 to 0.9 wt %, more specifically from 0.7 to 0.9 wt %, even more specifically 0.8 to 0.9 wt %.

According to still a further embodiment, the cyclic dimer content in the polyarylene(ether)sulfone composition obtainable by the inventive process is from 0.1 to 0.8 wt %, in particular from 0.2 to 0.8 wt %, more specifically from 0.3 to 0.8 wt %, even more specifically 0.4 to 0.8 wt %. It may also be preferred if the cyclic dimer content is from 0.5 to 0.8 wt %, in particular from 0.6 to 0.8 wt %, more specifically from 0.7 to 0.8 wt %.

According to still a further embodiment, the cyclic dimer content in the polyarylene(ether)sulfone composition obtainable by the inventive process is from 0.1 to 0.7 wt %, in particular from 0.2 to 0.7 wt %, more specifically from 0.3 to 0.7 wt %, even more specifically 0.4 to 0.7 wt %. It may also be preferred if the cyclic dimer content is from 0.5 to 0.7 wt %, in particular from 0.6 to 0.7 wt %.

According to still a further embodiment, the cyclic dimer content in the polyarylene(ether)sulfone composition obtainable by the inventive process is from 0.1 to 0.6 wt %, in particular from 0.2 to 0.6 wt %, more specifically from 0.3 to 0.6 wt %, even more specifically 0.4 to 0.6 wt %. It may also be preferred if the cyclic dimer content is from 0.5 to 0.6 wt %.

According to still a further embodiment, the cyclic dimer content in the polyarylene(ether)sulfone composition obtainable by the inventive process is from 0.1 to 0.5 wt %, in particular from 0.2 to 0.5 wt %, more specifically from 0.3 to 0.5 wt %, even more specifically 0.4 to 0.5 wt %.

According to still a further embodiment, the cyclic dimer content in the polyarylene(ether)sulfone composition obtainable by the inventive process is from 0.1 to 0.4 wt %, in particular from 0.2 to 0.4 wt %, more specifically from 0.3 to 0.4 wt %.

According to still a further embodiment, the cyclic dimer content in the polyarylene(ether)sulfone composition obtainable by the inventive process is from 0.1 to 0.3 wt %, in particular from 0.2 to 0.3 wt %, more specifically from 0.1 to 0.2 wt %.

Furthermore, it is surprising, that by using the inventive process as described herein in detail also very low amounts of cyclic oligomers different from cyclic dimers are contained in the produced polymer product. This is achieved by the process itself without performing a subsequent purification step in order to remove oligomers from the reaction product. In general “cyclic oligomers” are unwanted side products that can be formed during polycondensation, wherein the linear condensation products of different lengths react under ring closure, for example wherein the linear condensation products from
three monomers A) and three monomers B) react under ring closure (“cyclic trimer” in the following);
four monomers A) and four monomers B) react under ring closure (“cyclic tetramer” in the following);
five monomers A) and five monomers B) react under ring closure (“cyclic pentamer” in the following);
six monomers A) and six monomers B) react under ring closure (“cyclic hexamer” in the following);
seven monomers A) and seven monomers B) react under ring closure (“cyclic heptamer” in the following);
eight monomers A) and eight monomers B) react under ring closure (“cyclic octamer” in the following);
nine monomers A) and nine monomers B) react under ring closure (“cyclic nonamer” in the following); and/or
ten monomers A) and ten monomers B) react under ring closure (“cyclic decamer” in the following).

Each of said cyclic oligomers is preferably independently comprised in the inventive polymer obtained by the inventive process in an amount of less than or equal to 1.1 wt % (0 to 1.1 wt %), in particular less than or equal to 1.0 wt % (0 to 1.0 wt %), more specifically less than or equal to 0.9 wt % (0 to 0.9 wt %). The preferred ranges as given for the cyclic dimer above apply independently for each of the cyclic oligomers (trimer, tetramer, pentamer, hexamer, heptamer, octamer, nonamer, decamer).

The content of cyclic oligomers can for example be determined by means of Size Exclusion Chromatography that is well-known to the skilled person. By means of for example Maldi-TOF mass spectrometry, the individual cyclic oligomers can be identified. The cyclic oligomers do not have end groups and can therefore be distinguished from linear oligomers also having low molecular weights compared to the desired polymer product.

Furthermore, it is also surprising that the inventive process parameters result in poly-arylene(ether)sulfone polymer (P) with very low contents of aromatic volatiles without carrying out a subsequent purification step to remove the aromatic volatiles from the reaction product. “Aromatic volatiles” that are to be avoided as contaminants in the polyarylene(ether)sulfone polymer (P) are for example selected from toluene, ethyl benzene, o-xylene, m-xylene, p-xylene and chlorobenzene.

The product of the inventive process preferably comprises less than 100 ppm, more preferably less than 50 ppm, even more specifically less than 30 ppm, still more specifically less than 20 ppm of each of the aromatic volatile detailed above, based on the total weight of the polymer product, wherein the amounts apply independently for each of the volatiles. More preferably, the product of the inventive process preferably comprises less than 15 ppm, more preferably less than 10 ppm, even more specifically less than 5 ppm, still more specifically less than 3 ppm of each of the aromatic volatile detailed above, based on the total weight of the polymer product, wherein the amounts apply independently for each of the volatiles.

In a very specific embodiment, the product of the inventive process preferably comprises in sum less than 100 ppm, more preferably less than 50 ppm, even more specifically less than 30 ppm, still more specifically less than 20 ppm of the aromatic volatiles detailed above. More preferably, the product of the inventive process preferably comprises in sum less than 15 ppm, more preferably less than 10 ppm, even more specifically less than 5 ppm, still more specifically less than 3 ppm of the aromatic volatiles detailed above.

According to one embodiment, the product of the inventive process preferably comprises less than 100 ppm, more preferably less than 50 ppm, even more specifically less than 30 ppm, still more specifically less than 20 ppm of chlorobenzene, based on the total weight of the polymer product. More preferably, the product of the inventive process preferably comprises less than 15 ppm, more preferably less than 10 ppm, even more specifically less than 5 ppm, still more specifically less than 3 ppm of chlorobenzene, based on the total weight of the polymer product.

According to a further embodiment, the product of the inventive process preferably comprises less than 100 ppm, more preferably less than 50 ppm, even more specifically less than 30 ppm, still more specifically less than 20 ppm of toluene, based on the total weight of the polymer product. More preferably, the product of the inventive process preferably comprises less than 15 ppm, more preferably less than 10 ppm, even more specifically less than 5 ppm, still more specifically less than 3 ppm of toluene, based on the total weight of the polymer product.

According to still a further embodiment, the product of the inventive process preferably comprises less than 100 ppm, more preferably less than 50 ppm, even more specifically less than 30 ppm, still more specifically less than 20 ppm of chlorobenzene and toluene, based on the total weight of the polymer product. More preferably, the product of the inventive process preferably comprises less than 15 ppm, more preferably less than 10 ppm, even more specifically less than 5 ppm, still more specifically less than 3 ppm of chlorobenzene and toluene, based on the total weight of the polymer product.

In particular, the polyarylene(ether)sulfone composition obtainable by the inventive process is essentially free of chlorobenzene. In a further embodiment, the polyarylene(ether)sulfone composition obtainable by the inventive process is essentially free of toluene. According to a further embodiment, the polyarylene(ether)sulfone composition obtainable by the inventive process is essentially free of toluene and chlorobenzene. According to still a further embodiment, the poly-arylene(ether)sulfone composition obtainable by the inventive process is essentially free of aromatic volatiles, in particular as defined above. The term “essentially free” in this context is understood to mean that the product may only contain neglectable traces of the respective aromatic volatile(s).

It is furthermore preferred that the polyarylene(ether)sulfone does not comprise chlorobenzene. It is furthermore preferred that the polyarylene(ether)sulfone does not comprise toluene, and even more preferred if the polyarylene(ether)sulfone does not comprise chlorobenzene or toluene. It is particularly preferred if the polyarylene(ether)sulfone does not comprise any aromatic volatile substance as listed above.

Consequently, a further object of the present invention is the polyarylene(ether)sulfone composition obtainable by the inventive process as described herein. In particular, the inventive poly-arylene(ether)sulfone has high molecular weight as defined and preferably defined above (e.g. V.N. >65 ml/g), cyclic dimer contents as defined and preferably defined above as well as low contents on aromatic volatiles such as chlorobenzene as detailed (including preferred embodiments) above.

A further advantage of the inventive process is that it yields firsthand polyarylene(ether)sulfone polymer (P) with high purity, measurable by means of the turbidity of the polymer product. Methods for the measurement of turbidity are well-known to the skilled person.

The purity of the product may for example be characterized by turbidity measurements using a solution containing 20 wt. % of polymer in DMF employing a Hach TL2360 Photometer. This apparatus is calibrated internally, and the results are given as “N.T.U.” (nephelometric turbidity units), in a range of 0 bis 40 N.T.U. The solutions are preferably prepared and then allowed to equilibrate for 24 h before the measurement is being done. Then, a second measurement may be carried out after some storage time of the solutions, for example after storage in the dark for 7 days. The outcome of this second measurement is very meaningful specifically for determining whether a polymer is suitable for industrial applications, such as for example for the production of membranes.

According to a preferred embodiment of the invention, the polyarylene(ether)sulfone polymer (P) obtained from the inventive process shows a turbidity of 0 to 1.75, preferably 0 to 1.74, after 24 h, using the Hach TL2360 Photometer and the method described above. Furthermore, according to a further preferred embodiment, the polyarylene(ether)sulfone polymer (P) obtained from the inventive process shows a turbidity of 0 to 1.95, preferably 0 to 1.90 after 7 days, using the Hach TL2360 Photometer and the method described above. According to a further preferred embodiment, the turbidity of the first (24 hours) and the second (7 days) measurements using the using the Hach TL2360 Photometer and the method described above is 0 to 1.95, preferably 0 to 1.90.

Low turbidity makes the products highly suitable for their use in membranes. The specific process parameters of the inventive process result in polymers with favorable turbidity values without the necessity for removing such impurities in a subsequent purification step.

As described above, particularly due to the low content of cyclic dimer and aromatic volatiles as well as the favorable purity of the inventive polyarylene(ether)sulfone it is highly suitable to be used in membrane production processes, particularly where the membranes are produced from solution.

The skilled person is familiar with the preparation of membranes. It is known that during the preparation of the membrane the solvent exchange usually leads to an asymmetric membrane structure. Therefore, the membrane is preferably asymmetric. In an asymmetric membrane the pore size increases from the top layer, which is used for separation, to the bottom of the membrane.

If the membrane is a porous membrane, then the membrane typically comprises pores. The pores usually have a diameter in the range from 1 nm to 10000 nm, preferably in the range from 2 to 500 nm and particularly preferably in the range from 5 to 250 nm determined via filtration experiments using a solution containing different PEG's covering a molecular weight from 300 to 1000000 g/mol. By comparing the GPC-traces of the feed and the filtrate, the retention of the membrane for each molecular weight can be determined. The molecular weight, where the membrane shows a 90% retention is considered as the molecular weight cutoff (MWCO) for this membrane under the given conditions. Using the known correlation between the Stoke diameters of PEG and their molecular weights, the mean pore size of a membrane can be determined. Details about this method are given in the literature (Chung, J. Membr. Sci. 531 (2017) 27-37). A porous membrane is typically obtained if the membrane is prepared via a phase inversion process.

A dense membrane typically comprises virtually no pores. A dense membrane is typically obtained by a solution casting process in which a solvent comprised in the casted solution is evaporated. Usually the separation layer (the solution which after the separation of the solvent gives the membrane) is casted on a support, which might be another polymer like polysulfone or celluloseacetate. On top of the separation layer sometimes a layer of polydimethylsiloxane is ap-plied.

The membrane can have any thickness. For example, the thickness of the membrane is in the range from 2 to 150 μm, preferably in the range from 3 to 100 μm and most preferably in the range from 5 to 60 μm. The inventive membrane can be used in any processes known to the skilled person in which membranes are used. In particular, if the membrane is a dense membrane, it is particular suitable for the gas separation

An object of the present invention is, thus, the use of the polyarylene(ether)sulfone polymer (P) or polyarylene(ether)sulfone polymer (P) composition obtained by the inventive process in a membrane.

According to one embodiment of the present invention the polyarylene(ether)sulfone polymer (P) of the invention is used in an asymmetric membrane. In a further embodiment, the membrane is porous.

In still another embodiment of the present invention the polyarylene(ether)sulfone polymer (P) is used in a dense membrane. Therefore, another object of the present invention is also a membrane, wherein the membrane is a dense membrane.

Another object of the present invention is also the use of the polyarylene ether (sulfone) polymer (P) obtainable by the inventive process in the manufacture of a membrane, wherein the manufacture comprises phase inversion from solution.

The membrane is particularly suitable for nanofiltration, microfiltration and/or ultrafiltration if the membrane is a porous membrane. Typical nanofiltration, ultrafiltration and microfiltration processes are known to the skilled person. For example, the membrane can be used in a dialysis process as dialysis membrane. The polyarylene(ether)sulfone polymer (P) obtainable by the inventive process is particularly suitable for the manufacture of a dialysis membrane.

Therefore, another object of the present invention is the use of the polyarylene(ether)sulfone polymer (P) obtainable by the inventive process in the manufacture of a membrane, in particular for the manufacture of a nanofiltration, ultrafiltration and/or microfiltration membrane. According to one particular embodiment, the polyarylene(ether)sulfone polymer (P) obtainable by the inventive process is used in the manufacture of an ultrafiltration membrane, such as a dialysis membrane. According to a further embodiment, the polyarylene(ether)sulfone polymer (P) obtainable by the inventive process is used in the manufacture of a gas separation membrane.

A further object of the present invention is a membrane comprising the polyarylene (ether)sulfone polymer (P) obtainable by the inventive process described herein. In particular, the membrane is a nanofiltration, ultrafiltration and/or microfiltration membrane, more specifically an ultrafiltration membrane. According to a further embodiment the membrane comprising the poly-arylene(ether)sulfone polymer (P) obtainable by the inventive process described herein is a gas separation membrane.

A membrane can be prepared from the polyarylene(ether)sulfone polymer (P) obtained according to the present invention by any method known to the skilled person.

A further object of the present invention is a method for the preparation of a membrane comprising the polyarylene(ether)sulfone polymer (P) obtainable by the inventive process, the method comprising the steps
i) providing a solution which comprises the polyarylene(ether)sulfone polymer (P) and at least one solvent;
ii) separating the at least one solvent from the solution to obtain the membrane.

The at least one solvent in step i) may be precisely one solvent or may be also a mixture of two or more solvents. The solution in step i) can be provided by any method known to the skilled person, for example in customary vessels which may comprise a stirring device and preferably a temperature control device. Preferably, the solution is provided by dissolving the poly-arylene(ether)sulfone polymer (P) in the at least one solvent, preferably under agitation. Step i) is preferably carried out at elevated temperatures, especially in the range from 20 to 120° C., more preferably in the range from 40 to 100° C. A person skilled in the art will choose the temperature in accordance with the at least one solvent. The solution preferably comprises the polyarylene(ether)sulfone polymer (P) completely dissolved in the at least one solvent. This means that the solution(S) preferably comprises no solid particles of the polyarylene (ether)sulfone polymer (P) and that the polyarylene(ether)sulfone polymer (P) preferably cannot be separated from the at least one solvent by filtration. The solution preferably comprises from 0.001 to 50% by weight of the polyarylene(ether)sulfone polymer (P) based on the total weight of the solution. More preferably, the solution in step i) comprises from 0.1 to 30% by weight of the polyarylene(ether)sulfone polymer (P) and most preferably the solution comprises from 0.5 to 25% by weight of the polyarylene(ether)sulfone polymer (P) based on the total weight of the solution. As the at least one solvent, any solvent known to the skilled person for the poly-arylene(ether)sulfone polymer (P) is suitable. Preferably, the at least one solvent is soluble in water. Therefore, the at least one solvent is preferably selected from the group consisting of N-methylpyrrolidone, dimethylacetamide, dimethylsulfoxide, dimethyllactamide, dimethylformamide and sulfolane. N-methylpyrrolidone and dimethyllactamide are particularly preferred. Dimethyllactamide is most preferred as the at least one solvent. The solution preferably comprises in the range from 50 to 99.999% by weight of the at least one solvent, more preferably in the range from 70 to 99.9% by weight and most preferably in the range from 75 to 99.5% by weight of the at least one solvent based on the total weight of the solution. The solution provided in step i) can furthermore comprise additives for the membrane preparation.

Suitable additives for the membrane preparation are known to the skilled person and are, for example, polyvinylpyrrolidone (PVP), polyethylene oxide (PEO), polyethylene oxide-polypropylene oxide copolymer (PEO-PPO) and poly(tetrahydrofurane) (poly-THF). Polyvinylpyrrolidone (PVP) and polyethylene oxide (PEO) are particularly preferred as additives for the membrane preparation. The additives for membrane preparation can, for example, be comprised in the solution in an amount of from 0.01 to 20% by weight, preferably in the range from 0.1 to 15% by weight and more preferably in the range from 1 to 10% by weight based on the total weight of the solution. To the person skilled in the art it is clear that the percentages by weight of the poly-arylene(ether)sulfone polymer (P), the at least one solvent and the optionally comprised additive(s) for membrane preparation comprised typically add up to 100% by weight.

The duration of step i) may vary between wide limits. The duration of step i) is preferably in the range from 10 min to 48 h (hours), especially in the range from 10 min to 24 h and more preferably in the range from 15 min to 12 h. A person skilled in the art will choose the duration of step i) so as to obtain a homogeneous solution.

In step ii) the at least one solvent is separated from the solution to obtain the membrane. It is possible to filter the solution provided in step i) before the at least one solvent is separated from the solution in step ii) to obtain a filtered solution. The following embodiments and preferences for separating the at least one solvent from the solution applies equally for separating the at least one solvent from the filtered solution which is used in this embodiment of the invention. The separation of the at least one solvent from the solution can be performed by any method known to the skilled person which is suitable to separate solvents from polymers. Preferably, the separation is carried out via a phase inversion process. If the separation of the at least one solvent is carried out via a phase inversion process, the obtained membrane is typically a porous membrane. A phase inversion process within the context of the present invention means a process wherein the dissolved polyarylene(ether)sulfone polymer (P) is transformed into a solid phase. Therefore, a phase inversion process can also be denoted as precipitation process. The person skilled in the art knows suitable phase inversion processes. The phase inversion process can, for example, be performed by cooling down the solution, wherein the poly-arylene(ether)sulfone polymer (P) comprised in this solution precipitates. Another possibility to perform the phase inversion process is to bring the solution in contact with a gaseous liquid that is a non-solvent for the polyarylene(ether)sulfone polymer (P). The polyarylene(ether)sulfone polymer (P) will then as well precipitate. Suitable gaseous liquids that are non-solvents for the polyarylene(ether)sulfone polymer (P) are for example protic polar solvents described hereinafter in their gaseous state. Another phase inversion process which is preferred within the context of the present invention is the phase inversion by immersing the solution into at least one protic polar solvent. Therefore, in one embodiment of the present invention, in step ii) the at least one solvent comprised in the solution is separated from the polyarylene(ether)sulfone polymer (P) by immersing the solution into at least one protic polar solvent. This leads to the formation of the membrane. Suitable at least one protic polar solvents are known to the skilled person. The at least one protic polar solvent is preferably a non-solvent for the polyarylene(ether)sulfone polymer (P). Preferred at least one protic polar solvents are water, methanol, ethanol, n-propanol, iso-propanol, glycerol, ethylene glycol and mixtures thereof. Step ii) usually comprises a provision of the solution in a form that corresponds to the form of the membrane which is obtained in step ii). Therefore, in one embodiment of the present invention step ii) comprises a casting of the solution to obtain a film of the solution or a passing of the solution through at least one spinneret to obtain at least one hollow fiber of the solution. Therefore, in one preferred embodiment of the present invention, step ii) comprise the following steps:
ii-1) casting the solution provided in step i) to obtain a film of the solution;
ii-2) evaporating the at least one solvent from the film of the solution obtained in step ii-1) to obtain the membrane which is in the form of a film.

This means that the membrane is formed by evaporating the at least one solvent from a film of the solution. In step ii-1) the solution can be cast by any method known to the skilled person. Usually, the solution is cast with a casting knife that is heated to a temperature in the range from 20 to 150° C., preferably in the range from 40 to 100° C. The solution is usually cast on a substrate that does not react with the polyarylene(ether)sulfone polymer (P) or the at least one solvent comprised in the solution. Suitable substrates are known to the skilled person and are, for example, selected from glass plates and polymer fabrics such as non-woven materials. To obtain a dense membrane, the separation in step ii) is typically carried out by evaporation of the at least one solvent comprised in the solution.

The obtained membrane comprises preferably at least 50% by weight of the poly-arylene(ether)sulfone polymer (P), more preferably at least 70% by weight and most preferably at least 90% by weight of the polyarylene(ether)sulfone polymer (P) based on the total weight of the membrane. In a further preferred embodiment, the membrane consists essentially of the polyarylene(ether)sulfone polymer (P). “Consisting essentially of” means that the membrane comprises more than 95% by weight, preferably more than 97.5% by weight and most preferably more than 98% by weight of the polyarylene(ether)sulfone polymer (P) based on the total weight of the membrane.

During the formation of the membrane the polyarylene(ether)sulfone polymer (P) is separated from the at least one solvent. Therefore, the obtained membrane is essentially free from the at least one solvent. “Essentially free” within the context of the present invention means that the membrane comprises at most 1% by weight, preferably at most 0.5% by weight and particularly preferably at most 0.1% by weight of the at least one solvent based on the total weight of the membrane. The membrane comprises at least 0.0001% by weight, preferably at least 0.001% by weight and particularly preferably at least 0.01% by weight of the at least one solvent based on the total weight of the membrane.

The embodiments and preferences given for the polyarylene(ether)sulfone polymer (P) obtained from the inventive process independently also apply to the polyarylene(ether)sulfone polymer (P) used in the membranes accordingly.

### EXAMPLES

The examples below provide further explanation of the invention without restricting the same.

The viscosity number of the obtained polyaryl(ether)sulfones is obtained by measurement in N-methylpyrrolidone (1 g in 100 ml solution; 25° C.) according to ISO 1628.

The content of cyclic oligomers was detected by Size Exclusion Chromatography with THE as solvent. The separation is done applying a combination of two columns of 30 cm length. The first column is filled with PIgel Mixed-ER and the second column with PLgel Mixed-E®. The separation was done at 30° C. and a flux rate of 1 ml/min. For detection a UV-detector operating at 254 nm was employed. For the detection of cycles in polyethersulfone, dichloromethane was used as solvent.

The purity of the product was further characterized by turbidity measurements using a solution containing 20 wt. % of polymer in DMF employing a Hach TL2360 Photometer. The apparatus is calibrated internally, and the results are given as “N.T.U.” (nephelometric turbidity units), in a range of 0 bis 40 N.T.U. with a precision of +/−2% of the measured value. The solutions were prepared and then allowed to equilibrate for 24 h before the measurement was done. Then the solutions were stored in the dark for 7 days and the measurement was repeated then.

The content of chlorobenzene was determined by GC-analysis. For this purpose, 0.250 g polymer were given into a headspace-vial and 1 ml DMAc were added. The vial was rolled until the material was completely dissolved. Then the vial was heated to 90° C. for 1 h and the gas phase was analyzed using a GC-system with DB WAX-column and FID-detector.

### Example C1

In a 4 liter glass reactor fitted with a thermometer, a gas inlet tube and a Dean-Stark-trap, 608.78 g (2.12 mol) of DCDPS, 483.97 g (2.12 mol) of Bisphenol A and 307.65 g (2.226 mol) of potassium carbonate with a volume average particle size of 33 μm were suspended in 1000 ml NMP in a nitrogen atmosphere at 23° C.

The mixture was heated to 190° C. within 270 minutes. In the following, the reaction time shall be understood to be the time during which the reaction mixture was maintained at 190° C. The water that was formed in the reaction was continuously removed by distillation, evaporated NMP was replenished.

After a reaction time of 7 hours, the reaction was stopped by the addition of 1400 ml NMP and cooling down to 130° C. (within one hour). Then the mixture was reacted at this temperature with methylchloride for 45 minutes, the mixture was cooled to room temperature, stripped with nitrogen. The potassium chloride formed in the reaction was removed by filtration. The obtained polymer solution was then precipitated in water, the resulting polymer beads were separated and then extracted with hot water (85° C.) for 20 h. Then the beads were dried at 120° C. for 24 h at reduced pressure (<100 mbar)

The details of the reaction conditions of all other trials are summarized in table 1. C1, C2, C5 and C8 are comparison examples not using the combination of process parameters found according to the invention.

TABLE 1

| | C1 | C2 | 3 | 4 | C5 | 6 | 7 | C8 | C9 |
|---|---|---|---|---|---|---|---|---|---|
| monomer con- | 2.12 | 2.12 | 2.22 | 2.42 | 2.42 | 2.42 | 2.42 | 2.72 | — |
| centration: mol | | | | | | | | | |
| per liter of sol- | | | | | | | | | |
| vent compo- | | | | | | | | | |
| nent D) | | | | | | | | | |
| component D) | 1000 | 1000 | 1000 | 1000 | 1000 | 1000 | 1000 | 1000 | |
| | ml | ml | ml | ml | ml | ml | ml | ml | |
| | NMP | NMP | NMP | NMP | NMP | NMP | NMP | NMP | |
| heating rate | 0.61 | 0.35 | 0.61 | 0.61 | 0.35 | 0.5 | 0.61 | 0.61 | — |
| [K/min.] | | | | | | | | | |
| Excess base | 5 | 5 | 5 | 5 | 5 | 5 | 7.5 | 7.5 | — |
| C) [mol %] | | | | | | | | | |
| V.N. [ml/g] | 79.0 | 82.5 | 72.8 | 66.7 | 69.9 | 68.9 | 79.1 | 34.7 | 79.2 |
| cyclic dimer | 1.3 | 1.4 | 1.2 | 1.0 | 1.3 | 1.1 | 1.0 | 1.0 | 1.1 |
| [wt. %] | | | | | | | | | |
| Turbidity | | | | | | | | | |
| [N.T.U.] | | | | | | | | | |
| Day 1 | 2.23 | 2.67 | 1.56 | 1.65 | 1.98 | 1.71 | 1.74 | 1.89 | 1.75 |
| Day 7 | 7.83 | 9.56 | 1.62 | 1.71 | 7.03 | 1.87 | 1.89 | 2.01 | 4.67 |
| chlorobenzene | 0 | 0 | 0 | 0 | 0 | 0 | 0 | 0 | 250 |
| [ppm] | | | | | | | | | |

The material prepared according to the claimed conditions shows a unique combination of properties like high V.N., low dimer content, excellent purity as indicated by the turbidity measurements and contain no chlorobenzene. (C9=material: Udel P-3500 LCD, commercially available from Solvay)

1.-14. (canceled)

15. A process for the preparation of a polyarylene(ether)sulfone polymer (P) comprising:
I) providing a reaction mixture R^{M} at a start temperature T¹, the reaction mixture comprising
A) at least one aromatic dihalogen sulfone;
B) at least one dihydroxy component;
C) at least one carbonate component in an excess amount of at least 3 mol % in relation to the dihydroxy component B);
D) at least one aprotic solvent;
wherein the initial concentration of each of the monomers A) and B) in the reaction mixture R^{M} is 2.2 to 2.7 mol per one liter of the at least one aprotic solvent D); and
II) heating the reaction mixture R^{M} from the start temperature T¹ to the final reaction temperature T^{F} with a rate of at least 0.4 K/min, wherein a product mixture P^{M} is obtained.

16. The process of claim 15, wherein A) is at least one dihalodiphenyl sulfone.

17. The process of claim 15, wherein the at least one dihydroxy component B) is selected from dihydroxybiphenyls, bisphenylpropanes and bisphenyl sulfones.

18. The process of claim 15, wherein component D) is selected from N-methylpyrrolidone, N-dimethylacetamide, dimethylsulfoxide and dimethylformamide.

19. A method comprising utilizing the polyarylene(ether)sulfone polymer (P) obtained by the process according to claim 15 in a membrane.

20. A method comprising utilizing the polyarylene(ether)sulfone polymer (P) obtained by the process according to claim 15 in the manufacture of a membrane.

21. The method of claim 19, wherein the membrane is a nanofiltration, ultrafiltration or microfiltration membrane.

22. The method of claim 19, wherein the membrane is a gas separation membrane.

23. A membrane comprising a polyarylene(ether)sulfone polymer (P) obtained by the process according to claim 15.

24. A polyarylene(ether)sulfone obtained by the process according to claim 15.

25. The polyarylene(ether)sulfone of claim 24 having a Viscosity Number of >65 ml/g and a cyclic dimer content of equal to or lower than 1.1 wt %.

26. The polyarylene(ether)sulfone of claim 24 containing less than or equal to 100 ppm chlorobenzene.

27. The polyarylene(ether)sulfone of claim 24 showing a turbidity of 0 to 1.75, preferably 1.74, N.T.U after 24 h, using a Hach TL2360 Photometer.

28. The polyarylene(ether)sulfone of claim 24, wherein the turbidity after 24 hours and the turbidity after 7 days is 0 to 1.95, preferably 0 to 1.90 N.T.U., using a Hach TL2360 Photometer.
